(19) United States
(12) Patent Application Publication
(10) Pub. No.: US 2005/0106937 A1
(43) Pub. Date: May 19, 2005

(54) Memory card connector with improved board locking means

(76) Inventor: Tung-Chang Lin, Taipei Hsien (TW)

Correspondence Address: MOLEX INCORPORATED, 2222 WELLINGTON COURT, LISLE, IL, 60532, US

(21) Appl. No.: 10/935,862

(22) Filed: Sep. 8, 2004

(30) Foreign Application Priority Data
Sep. 17, 2003 (TW) 92216710

(51) Int. Cl. H01R 13/60

(52) U.S. Cl. 439/567

(57) ABSTRACT

A memory card connector is provided for mounting on a printed circuit board. The connector includes an insulating housing having a rear terminal-mounting section and at least one longitudinal side wall section extending forwardly from one end of the rear section and combining therewith to define a card-receiving space for receiving a memory card in an insertion direction. The side wall section has an inside longitudinal groove for receiving a side edge of the memory card, along with a plurality of insertion slots. A plurality of conductive terminals are mounted on the rear terminal-mounting section of the housing. The terminals have contact portions projecting into said space for engaging appropriate contacts on the memory card. A locking member is mounted on the side wall section of the housing. The locking member includes (a) a body portion positioned in the inside longitudinal groove of the side wall section, (b) a plurality of fixing tabs extending from the body portion and secured in the insertion slots, and (c) a fastening portion extending from the body portion for securement to the printed circuit board.

### FIELD OF THE INVENTION

This invention generally relates to the art of electrical connectors and, particularly, to a memory card connector for mounting on a printed circuit board and including new and improved locking members.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like. The card may be used in applications such as mobile or cellular telephones which are actuated and permit data access after identifying an identification code stored on a SIM (subscriber identification module) card. The SIM card has a conductive face with an array of contacts, and the mobile phone has a SIM card connector with terminals for electrical connection with the contacts of the SIM card to ensure the subscriber identification confirmation.

A typical memory card connector includes some form of dielectric housing which, with or without a metal shell, defines a card-receiving cavity or space. The dielectric housing may be generally L-shaped or U-shaped and includes a rear terminal-mounting section at the rear of the card-receiving space, and at least one longitudinal side wall section extending from one or both ends of the rear section at one or both sides of the cavity.

When the above-described connector structure is mounted on a printed circuit board, some form of reinforcement means or locking members are provided for securing the connector to the printed circuit board. In addition, one or more grounding terminals are provided for engaging a ground portion typically at an edge of the memory card. The grounding terminal is connected to an appropriate grounding trace on the printed circuit board. The grounding terminal forms a grounding loop between the memory card and the printed circuit board to reduce noise during data transmission and improve transmission performance.

Problems have been encountered with grounding terminals in prior art memory card connectors. Specifically, the grounding terminals have a tendency to loosen or even break which cannot provide a reliable grounding function. A typical grounding terminal of the prior art is generally L-shaped and includes one portion insertable into the connector housing and a second portion for connection to the printed circuit board. This single securement of the grounding terminal to the housing is insufficient to fix the terminal to the housing for repeated insertions and removals of the memory card into and out of the connector. The present invention is directed to solving these problems.

### SUMMARY OF THE INVENTION

An object, therefore, of the invention is to provide a memory card connector with new and improved means for locking the connector to a printed circuit board.

In the exemplary embodiment of the invention, the connector includes an insulating housing having a rear terminal-mounting section and at least one longitudinal side wall section extending forwardly from one end of the rear section and combining therewith to define a card-receiving space for receiving a memory card in an insertion direction. The side wall section has an inside longitudinal groove for receiving a side edge of the memory card, along with a plurality of insertion slots. A plurality of conductive terminals are mounted on the rear terminal-mounting section of the housing. The terminals have contact portions projecting into said space for engaging appropriate contacts on the memory card. A locking member is mounted on the side wall section of the housing. The locking member includes (a) a body portion positioned in the inside longitudinal groove of the side wall section, (b) a plurality of fixing tabs extending from the body portion and secured in the insertion slots, and (c) a fastening portion extending from the body portion for securement to the printed circuit board.

As disclosed herein, the body portion of the locking member comprises a plate oriented in a plane generally parallel to the insertion direction. The fixing tabs extend generally perpendicular to the plate and generally perpendicular to the insertion direction. The fastening portion comprises a fastening pin extending downwardly from the body portion for insertion into a locking hole in the printed circuit board. The fastening pin is slit lengthwise thereof to define a bifurcated pin.

The housing is disclosed herein as being generally U-shaped to include a pair of the longitudinal side wall sections extending forwardly from both opposite ends of the rear terminal-mounting section of the housing. At least one of the locking members is mounted on each side wall section. As disclosed herein, one of the locking members is mounted near a front end as well as a rear end of each side wall section.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded perspective view of a memory card connector according to the invention, in conjunction with a printed circuit board and a memory card to be inserted into the connector;

FIG. 1A is an enlarged depiction of the area encircled at “A” in FIG. 1;

FIG. 2 is a perspective view of the connector mounted on the printed circuit board and the memory card inserted thereinto; and

FIG. 3 is an enlarged perspective view of one of the locking members.

### DETAILED DESCRIPTION OF THE PREFERRED EMBODIMENT

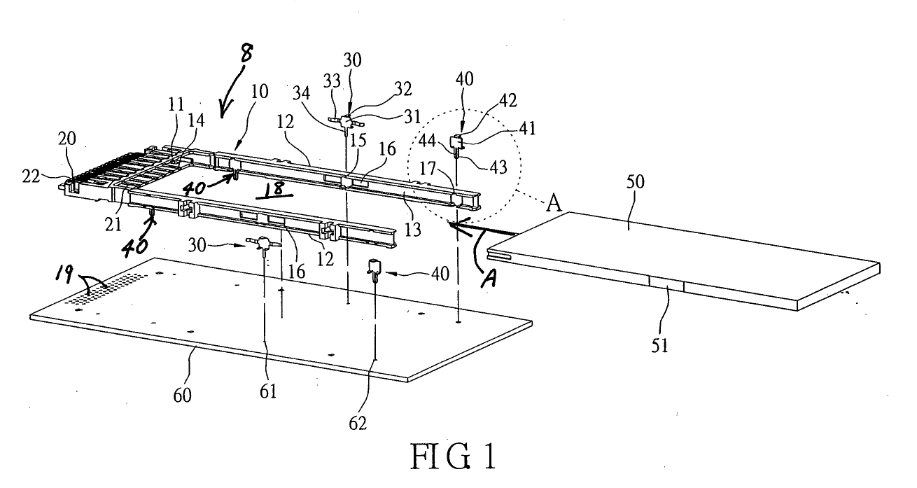

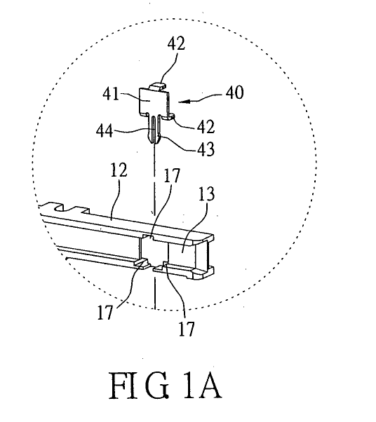

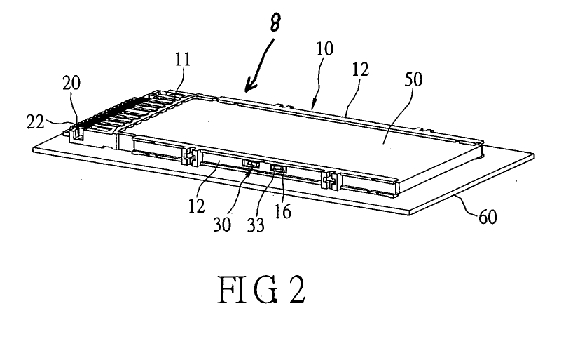

Referring to the drawings in greater detail, and first to FIGS. 1-2, the invention is embodied in a memory card connector, generally designated 8, for receiving a memory card in the direction of arrow “A” (FIG. 1) to a fully inserted position shown in FIG. 2. The connector is mounted on a printed circuit board 60. The memory card has a ground portion or contact 51 in each opposite side edge thereof. Only one ground contact 51 is visible in FIG. 1.

Memory card connector 8 includes a housing, generally designated 10, which is fabricated of insulating material such as molded plastic. The housing may be generally U-shaped (as shown) or L-shaped (not shown). In either event, the housing has a rear terminal-mounting section 11 and a pair of side wall sections 12 extending forwardly from opposite sides of the rear section. Each side wall section has an inside longitudinal groove 13 for receiving a side edge of the memory card. A plurality of terminal-receiving slots are formed on rear section 11. Each side wall section 12 includes a plurality of insertion slots 15, along with a pair of openings 16 at opposite sides thereof for securely mounting a grounding terminal, generally designated 30 and described hereinafter. Each side wall section also includes a plurality of insertion slots 17 inside the front end and the rear end of each side wall section for receiving a plurality of locking members, generally designated 40 and described hereinafter. The rear terminal-mounting section 11 and the pair of side wall sections 12 define a card-receiving space 18 (FIG. 1) between the side wall sections, with the rear section traversing the space.

A plurality of conductive terminals, generally designated 20, are mounted on the rear terminal-mounting section 11 of housing 10. The terminals have contact portions 21 extending forwardly into space 18, with the contact portions disposed in slots 14, for engaging appropriate contacts on memory card 50. The terminals have tail portions 22 for insertion into a plurality of holes 19 (FIG. 1) in the circuit board for connection, as by soldering, to appropriate circuit traces on the board and/or in the holes.

Each grounding terminal 30 includes a body portion 31 positioned in the respective inside longitudinal groove 13 of the respective side wall section 12. The grounding terminal is stamped and formed of conductive sheet metal material, and body portion 31 is in the form of a grounding plate oriented in a plane generally parallel to insertion direction “A” (FIG. 1).

Each grounding terminal 30 includes a plurality of fixing tabs 32 extending generally perpendicular to the body portion and generally perpendicular to the insertion direction. The fixing tabs are secured in insertion slots 15 by a tight press-fit. A pair of elongated elastic contact arms 33 extend from opposite sides of body portion 31 generally parallel to the insertion direction. The elastic contact arms are aligned with openings 16 in the respective side wall section 12. Finally, a grounding portion in the form of a grounding pin 34 extends downwardly from body portion 31 for insertion into a hole 61 (FIG. 1) in printed circuit board 60 for connection, as by soldering, to an appropriate grounding trace on the board and/or in the hole.

When memory card connector 50 is inserted into space 18 of housing 10 between side wall sections 12, ground contacts 51 at opposite edges of the memory card engage elastic contact arms 33 of grounding terminals 30. The elastic contact arms are free to flex into openings 16 in side wall sections 12. The grounding terminals form a grounding loop between the printed circuit board and the memory card to reduce noise during data transmission and improve transmission performance. The plurality of fixing tabs 32 being tightly secured within the plurality of insertion slots 15 in the side walls sections provide multiple fixing points to positively secure the grounding terminals and prevent the terminals from loosening due to multiple insertions and withdrawals of memory card 50.

As can be seen in FIG. 1, four locking members 40 are mounted on housing 10 of connector 8 to securely fix the connector to printed circuit board 60. One locking member is mounted near the front end and the rear end of each side wall section 12.

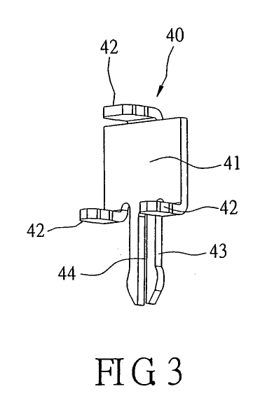

Locking terminals 40 are best shown in the enlarged depictions of FIGS. 1A and 3. Each locking member 40 includes a body portion 41 positioned in the inside longitudinal groove 13 of the respective side wall section. The locking member is stamped and formed of sheet metal material, and body portion 41 comprises a plate oriented in a plane generally parallel to insertion direction “A” (FIG. 1). Each locking member 40 includes a plurality of fixing tabs 42 which extend generally perpendicular to body portion 41 and generally perpendicular to the insertion direction. The fixing tabs are tightly press-fit into the plurality of insertion slots 17 in the inside of the respective side wall section. Finally, a fastening portion 43 extends downwardly from body portion 41 for securement to the printed circuit board. In the illustrated embodiment, fastening portion 43 is provided by a fastening pin which extends downwardly from body portion 41 for insertion into a locking hole 62 (FIG. 1) in printed circuit board 60. The fastening pin is slit lengthwise thereof to define a bifurcated locking pin.

As with grounding terminals 30, locking members 40 have a plurality of securement points provided by fixing tabs 42 tightly press-fit into insertion slots 17 in the side wall sections. This provides a positive and secure mounting of connector 8 to printed circuit board 60 and withstands multiple insertions and withdrawals of memory card connector 50 into and out of the card-receiving space 18 of the connector.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector for mounting on a printed circuit board, comprising:
an insulating housing having a rear terminal-mounting section and at least one longitudinal side wall section extending forwardly from one end of the rear section and combining therewith to define a card-receiving space for receiving a memory card in an insertion direction, the side wall section having an inside longitudinal groove for receiving a side edge of the memory card and a plurality of insertion slots;
a plurality of conductive terminals mounted on the rear terminal-mounting section of the housing and having contact portions projecting into said space for engaging appropriate contacts on the memory card; and
a locking member mounted on the side wall section of the housing and including a body portion positioned in said inside longitudinal groove, a plurality of fixing tabs extending from the body portion and secured in said insertion slots, and a fastening portion extending from the body portion for securement to the printed circuit board.

2. The memory card connector of claim 1 wherein the body portion of said locking member comprises a plate oriented in a plane generally parallel to said insertion direction.

3. The memory card connector of claim 1 wherein the fixing tabs of said locking member extend in a direction generally perpendicular to said insertion direction.

4. The memory card connector of claim 1 wherein the fastening portion of said locking member comprises a fastening pin extending downwardly from the body portion for insertion into a locking hole in the printed circuit board.

5. The memory card connector of claim 4 wherein said fastening pin is slit lengthwise thereof to define a bifurcated pin.

6. The memory card connector of claim 1, including one of said longitudinal side wall sections extending forwardly from both opposite ends of the rear terminal-mounting section of the housing, and one of said locking members is mounted on each side wall section.

7. The memory card connector of claim 6 wherein one of said locking members is mounted near a front end and near a rear end of each side wall section.

8. A memory card connector for mounting on a printed circuit board, comprising:
an insulating housing having a rear terminal-mounting section and at least one longitudinal side wall section extending forwardly from one end of the rear section and combining therewith to define a card-receiving space for receiving a memory card in an insertion direction, the side wall section having an inside longitudinal groove for receiving a side edge of the memory card and a plurality of insertion slots;
a plurality of conductive terminals mounted on the rear terminal-mounting section of the housing and having contact portions projecting into said space for engaging appropriate contacts on the memory card; and
a locking member mounted on the side wall section of the housing and including (a) a body portion in the form of a plate positioned in said inside longitudinal groove and oriented in a plane generally parallel to said insertion direction, (b) a plurality of fixing tabs extending generally perpendicular to the plate and generally perpendicular to said insertion direction and secured in said insertion slots, and (c) a fastening portion in the form of a fastening pin extending downwardly from the plate for insertion into a locking hole in printed circuit board to secure the connector to the board.

9. The memory card connector of claim 8 wherein said fastening pin is slit lengthwise thereof to define a bifurcated pin.

10. The memory card connector of claim 8, including one of said longitudinal side wall sections extending forwardly from both opposite ends of the rear terminal-mounting section of the housing, and one of said locking members is mounted on each side wall section.
